(19) United States
(12) Patent Application Publication
(10) Pub. No.: US 2010/0036673 A1
(43) Pub. Date: Feb. 11, 2010

(54) MATCHMAKING SERVICE WITH PROXIMITY BASED INTRODUCTORY ENCOUNTER

(76) Inventor: Anthony Chu, Passaic, NJ (US)

Correspondence Address: ITALIA IP, 3500 WEST OLIVE AVE., SUITE 300, BURBANK, CA, 91505, US

(21) Appl. No.: 12/189,041

(22) Filed: Aug. 8, 2008

(51) Int. Cl. G06Q 10/00

(52) U.S. Cl. 705/1

(57) ABSTRACT

A method of operating a matchmaking service, to include the feature of monitoring geographic proximity of paired participants deemed to be matched by computerized compatibility analysis, and communicating signals to each when a predetermined threshold of geographic proximity is achieved. Proximity is monitored using for example GPS enabled communications devices, such as cellular phones, which may be used to receive the signals. The signals may include previously logged characteristics of each member of the pair. The participants may then respond affirmatively to the signals or alternatively may decline the opportunity to meet.

### FIELD OF THE INVENTION

The present invention relates to a system for enabling an initial meeting or introduction of paired subscribers of matchmaking services.

### BACKGROUND OF THE INVENTION

So called dating services have been implemented for enabling people to meet others who are interested in dating, marriage, friendship, and general social or business contacts. These services may utilize computerized systems of matching up people according to common interests, characteristics, desires, and the like (hereinafter referred to as characteristics). The basic data providing the basis to judge or identify the characteristics is typically provided by data collected from each participant or subscriber. Suggested pairings are made when a requisite or threshold number of common characteristics is identified by computerized analysis of the collected data. Dating services, or matchmaking services, as this type of activity will be called herein, then bring the identity of identified paired people to the attention of the two, or make an offer to do so. In many cases, information relating to each member of the pair is made available to the other prior to either individual accepting the offered introduction. Once the introduction is made, typically by providing contact information to each party, it is left to the two to arrange an actual meeting.

Actually agreeing upon a meeting runs into the usual logistical constraints based on location of each party and scheduling a suitable free time for the encounter. Ability to schedule the intended face-to-face meeting or introduction may be delayed by geographic separation of the parties, conflicting schedules, and other factors. Successfully completing the meeting may therefore be objectionably delayed, or in more extreme cases, the quest may even be abandoned.

While conventional practice has resulted in successful introductions, there remains a need for people to make meetings more convenient.

### SUMMARY OF THE INVENTION

The present invention approaches the issue of convenience by monitoring geographic proximity of paired participants in a matchmaking service, and communicating to each when a predetermined threshold of proximity is achieved. Pairing may be accomplished for example by computerized compatibility analysis based on data pertaining to each member of the pair, which data has been entered into a database. Monitoring of proximity may be accomplished by monitoring location in real time using GPS enabled communications devices or any other positioning technology known or yet to be known in the possession of each participant. When paired participants are within predetermined proximity of one another, signals containing an invitation to meet one another are sent to the communication devices of the paired participants. These participants are then free to respond affirmatively to the signals or to decline the opportunity to meet.

It is therefore an object of the invention to exploit serendipitous occurrence of geographic proximity of paired candidates or participants in a matchmaking service.

It is an object of the invention to utilize location enabled communications devices to both monitor proximity of paired candidates and also to deliver messages advising availability of a person identified as being compatible for the matchmaking purpose.

It is an object of the invention to provide improved elements and arrangements thereof by apparatus for the purposes described which is inexpensive, dependable, and fully effective in accomplishing its intended purposes.

These and other objects of the present invention will become readily apparent upon further review of the following specification and drawings.

### BRIEF DESCRIPTION OF THE DRAWING

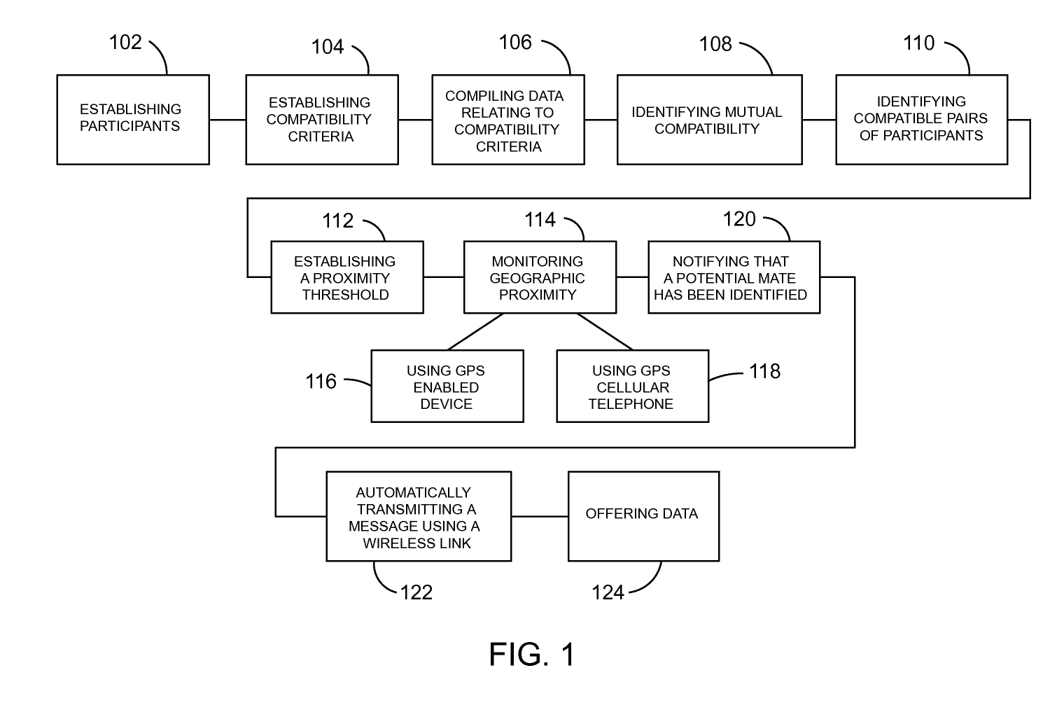

Various objects, features, and attendant advantages of the present invention will become more fully appreciated as the same becomes better understood when considered in conjunction with the accompanying drawing (FIG. 1), which is a block diagram of steps of practicing the inventive method, and is read starting from the upper left.

### DETAILED DESCRIPTION

In general terms, the invention concerns a method of offering an opportunity for two participants in a matchmaking arrangement to meet. More particularly, the invention seeks to exploit serendipitous proximity that may occur when two people who have been identified as meeting the criteria of a matchmaking arrangement engage in the course of routine travel during any particular day.

The matchmaking arrangement may include operational personnel who organize and manage or operate the matchmaking arrangement. The matchmaking arrangement also includes candidates for being matched. The matchmaking arrangement will be understood to encompass data processing apparatus or system for receiving inputs as to the identities of candidates for participation in the matchmaking arrangement, and inputs as to characteristics of the candidates, as well as all necessary supporting personnel, telecommunications systems, and other support features to assure operability. Identities may be entered into the data processing system by the operators of the matchmaking arrangement, may be entered by the candidates, or both. Data pertaining to identities may comprise names, pseudonyms, addresses, telephone numbers, membership numbers in an organization, one or more account numbers of an organization with which a candidate is associated, or other unique identifying data. Similarly, characteristics of the candidates may be entered into the data processing system by the operators of the matchmaking arrangement, by the candidates, or both. As used herein, reference to both operators and candidates entering data encompasses both redundant entries and also the situation which may occur when data for some candidates is entered by the candidates themselves, and data for other candidates is entered by the operators. Characteristics of the candidates will be understood to encompass both objective and subjective qualities, qualities of physical appearance such as height, weight, eye color, and other physiological data, and also mental characteristics, including opinions, philosophies and outlooks, preferences in a potential mate, general interests, personal objectives in participating in the matchmaking arrangements, and the like.

Data relating to characteristics of the candidates may then be compared using computer analysis as part of a process to find matches between desired characteristics and characteristics entered for potential mates. When a predetermined number of matches between any two participants has been determined in this process, the two participants may be regarded within the matchmaking arrangement as comprising an identified pair of participants or candidates. As employed herein, participants and candidates, which terms will be used interchangeably, will refer to those people for whom identities and characteristics have been entered with an eye to finding a mate. As employed herein, participants will be understood to be those people who have participated in the matchmaking arrangement in order to potentially be paired with or introduced to potentially compatible mates, as opposed to referring to organizing, administering, and operating personnel of the matchmaking organization. An identified pair will be understood as signifying two participants who have satisfied the compatibility criteria and who have been identified as falling within the predetermined proximity at any moment in time.

The term mate will refer to a participant who either actually or potentially meets the predetermined number of matches of characteristics which would result in meeting the criteria of the matchmaking arrangement to be considered compatible with another participant for purposes of being mutually introduced.

The arrangement described thus far is generally typical of conventional matchmaking arrangements. Most matchmaking arrangements exist for the purpose of generating meeting of people not known to each other, for romantic, sexual, or social purposes. Matchmaking arrangements according to any aspect of the present invention may encompass these purposes as well as others, such as roommate services, sports partners, investment partners, professional associations, and others. Therefore, it will be understood that the term matchmaker and its variants is not to be construed as limited in ultimate purpose.

With the foregoing background in mind, and referring to the Drawing Figure (FIG. 1) which summarizes elements of the method, the novel method 100 may comprise the following steps.

A step 102 is that of establishing a plurality of participants in the matchmaking arrangement, where the participants want to be matched with a potential mate. This can be done in any known way.

A step 104 is that of establishing compatibility criteria relating to the participants in the matchmaking arrangement. Compatibility criteria in most matchmaking schemes is predicated on matches between two sets of personal characteristics of two potential mates, where personal characteristics may be the characteristics previously discussed. The actual criteria are not important to the invention, and may be varied to suit. For example, a simple number of matches may establish compatibility. Certain categories of personal characteristics may be weighted relative to others, so that a threshold of values must be met. Similarity in a minimum number of categories may possibly be demanded.

Establishing compatibility criteria may include at least one criterion relating to physical appearance of an intended mate, such as height, weight, eye color, facial appearance, and the like, as described prior. Establishing compatibility criteria may also include at least one criterion based on an emotional goal or mental aspect of an intended mate, such as opinions, philosophies and outlooks, preferences in a potential mate, general interests, personal objectives in participating in the matchmaking arrangements, and the like, as discussed prior.

A step 106 is that of collecting and compiling data relating to the compatibility criteria from individual participants in the matchmaking arrangement. Data may be supplied by the participants, entered by the organizers and managers of the matchmaking arrangement, or both. Data may include textual descriptions, images, and the like. Data entry may be performed in any known way, including by having the participants use cellular telephones and personal computers to access over the internet a website operated by the matchmaking arrangement.

In a step 108 of identifying mutual compatibility of two participants participating in the matchmaking arrangement based on similarities in the collected data, a computer or other data processing device loaded with a comparison circuit or capability conducts a search for matches between the characteristics of any one selected participants and all other participants. Typically, this requires that potential mates of any one participant be of the opposite sex, and this may be stated as a criterion, especially where romantic and like purposes are being pursued, but such sexual discrimination is not critical to the invention.

When the data processing device has identified at least one potential mate, then the first participant being considered and each one of the potential mates deemed compatible with the first participant is regarded by the matchmaking system as an identified pair. Obviously, where compatibility is determined between one participant and a plurality of others, the one participant may become part of more than one identified pair. The aforedescribed process is the core of a step 110 of establishing identified pairs of participants deemed compatible, based on a process of identifying mutual compatibility. Of course, it is possible that for any one participant, only one identified pair results, or perhaps no identified pair results. In matchmaking arrangements involving relatively large numbers of participants, any one participant may be a member of plural identified pairs.

A significant aspect of the present invention is based on signaling potential availability of a mate who has been determined to be compatible with a particular participant as the result of the step of generating an identified pair or pairs, based on geographic proximity of the two participants. To this end, the novel method 100 may include a step 112 of establishing a predetermined proximity threshold. A proximity threshold may be based on geographic distance, occupancy of an arbitrary geographic location having predetermined boundaries, such as being within the confines of a building, a park, shopping center, town, or other identifiable or definable area, or according to any other location based criterion or criteria.

The method 100 includes a step 114 of monitoring geographic proximity of the various participants. Advantageously, the step 114 may include a further step 116 of utilizing a communications device which is location enabled and which is capable of transmitting location data to a remote monitoring station. This feature may be implemented by using a communications device such as a cellular telephone which is Global Positioning System (hereinafter referred to as GPS) enabled, which may be regarded as a step 118. The selected cellular telephones would of course be those known to be in the possession of the participants.

The matchmaking arrangement monitors locations of participants, and when predetermined proximity criteria are realized, automatically signals to or notifies each member of an identified pair that a potential mate who has been identified as being compatible is within the predetermined proximity threshold. This is shown as a step 120, which is performed in real time. That is, since people are mobile, proximity may be broken when one or both members of an identified pair continues to move about. Signaling of availability is for practical purposes instantaneous since the matchmaking arrangement preferably utilizes modern data processing apparatus for its various operations.

In a further aspect of the invention, the step of notifying that or signaling to each member of an identified pair comprises a step 122 of automatically transmitting a message using a wireless communications link. This may be for example a telephone call or instant message sent to the same cellular telephone which is relied upon to furnish location data for each participant. It is both practical and advantageous to utilize a GPS enabled cellular phone capable of displaying instant messages since this apparatus is routinely carried on the person of participants, and no burdensome additional apparatus is required. In summary, one routinely carried apparatus, that being a GPS enabled cellular telephone, serves the functions of providing location data to the matchmaking arrangement, receiving notification messages that identified pairs are within the specified proximity, and may also be exploited to add to the information which may be made available to notified participants.

For example, the step 122 of automatically transmitting a message may comprise the further step 124 of offering at least some data relating to one member of the identified pair to the other member of the identified pair to assist in making a decision whether to accept the introduction offer. The data relating to the one member is made available to the other member over the same communications channel which has been utilized to make initial contact with the identified pair when making the introduction offer. An example of further data which may be provided as described with respect to the step 124 is an image of the identified potential mate, which may then be displayed on the screen of the communications device.

The offer to provide additional data may be actively signaled, for example, by displaying a menu of choices on the screen of that participant who has just been advised of availability of a potential mate. Alternatively, the option to obtain data may be not signaled, but may require an affirmative step by the receiving party to obtain the sought data, such as soliciting data using the communications device.

A matchmaking arrangement will be understood to encompass both commercial or profit making entities and also those entities which engage in matchmaking for other purposes. Illustratively, religious, ethnic, and political and other groups may engage in matchmaking endeavors in order to serve their respective goals or those of their respective constituencies rather than to pursue financial gains.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

I claim:

1. A method of offering an opportunity for two participants in a matchmaking arrangement to meet, comprising the steps of:
establishing a plurality of participants in the matchmaking arrangement, where the participants want to be matched with a potential mate;
establishing compatibility criteria relating to the participants in the matchmaking arrangement;
collecting data relating to the compatibility criteria from the participants in the matchmaking arrangement;
identifying mutual compatibility of two participants participating in the matchmaking arrangement based on similarities in the collected data;
establishing identified pairs of people deemed suitable for mutual introduction for the purposes of the matchmaking arrangement, based on the step of identifying mutual compatibility;
establishing a predetermined proximity threshold;
monitoring geographic proximity of participants who have been established as identified pairs in the step of establishing identified pairs by tracking location of a location enabled communications device known to be in the possession of the participants; and
signaling to each member of an identified pair wherein the two members have been identified as falling within the predetermined proximity threshold in the step of monitoring geographic proximity that a potential mate who has been identified as being compatible is within the predetermined proximity threshold.

2. The method of claim 1, wherein the step of monitoring geographic proximity utilizes a communications device which is location enabled.

3. The method of claim 1, wherein the step of monitoring geographic proximity utilizes a communications device which is Global Positioning System enabled.

4. The method of claim 1, wherein the step of signaling to each member of an identified pair comprises automatically transmitting a message using a wireless communications link.

5. The method of claim 2, wherein the communications device is a cellular telephone.

6. The method of claim 4, wherein the step of signaling to each member comprises the step of sending an instant message.

7. The method of claim 1, wherein the steps of monitoring geographic proximity and of signaling to each member each utilize the same apparatus for determining geographic location and for receiving signals sent by the matchmaking arrangement.

8. The method of claim 1, wherein the compatibility criteria include at least one criterion relating to physical appearance of an intended mate.

9. The method of claim 1, wherein the compatibility criteria include at least one criterion based on an emotional goal of an intended mate.

10. The method of claim 1, wherein the step of collecting data relating to the compatibility criteria is implemented by transfer of data being collected over the internet.

11. The method of claim 1, wherein the step of signaling to each member of an identified pair comprises the further step of offering at least some data relating to one member of the identified pair to the other member of the identified pair to assist in making a decision whether to accept the introduction offer, wherein the data relating to the one member is made available to the other member over the same communications channel which has been utilized to make initial contact with the identified pair when making the introduction offer.

12. The method of claim 1, comprising the further step of soliciting from the matchmaking arrangement additional data relating to characteristics of a potential mate the availability of whom has been signaled in the step of signaling to each member of an identified pair.

13. The method of claim 12, wherein transmission of additional data utilizes the same location enabled communications device known to be in the possession of one of the participants.

14. A method of offering an opportunity for two participants in a matchmaking arrangement to meet, comprising the steps of:
establishing a plurality of participants in the matchmaking arrangement, where the participants want to be matched with a potential mate;
establishing compatibility criteria relating to the participants in the matchmaking arrangement;
collecting data relating to the compatibility criteria from the participants in the matchmaking arrangement;
identifying mutual compatibility of two participants participating in the matchmaking arrangement based on similarities in the collected data;
establishing potential pairs of people deemed suitable for mutual introduction for the purposes of the matchmaking arrangement, based on the step of identifying mutual compatibility;
establishing a predetermined proximity threshold;
monitoring geographic proximity of participants who have been established as potential pairs in the step of establishing potential pairs; and
signaling to each member of an identified pair which has been identified as falling within the predetermined proximity threshold in the step of monitoring geographic proximity that a potential mate who has been identified as being compatible is within the predetermined proximity threshold, using a wireless location enabled communications device capable of receiving and storing a message.

15. The method of claim 14, wherein the communications device is a cellular telephone.

16. The method of claim 14, wherein the step of signaling to each member comprises the step of sending an instant message.

17. The method of claim 14, wherein the compatibility criteria include at least one criterion relating to physical appearance of an intended mate.

18. The method of claim 14, wherein the compatibility criteria include at least one criterion based on an emotional goal of an intended mate.

19. The method of claim 14, wherein the step of collecting data relating to the compatibility criteria is implemented by transfer of data being collected over the internet.

20. The method of claim 14, wherein the step of signaling to each member of an identified pair comprises the further step of offering at least some data relating to one member of the identified pair to the other member of the identified pair to assist in making a decision whether to accept the introduction offer, wherein the data relating to the one member is made available to the other member over the same communications channel which has been utilized to make initial contact with the identified pair when making the introduction offer.
